(19) United States
(12) Patent Application Publication
(10) Pub. No.: US 2026/0185400 A1
(43) Pub. Date: Jul. 2, 2026

(54) Panel to Prevent Floodwater from Entering through Doors and Windows

(71) Applicants: Hilton Randy Long, Jacksonville, FL (US); Tammy Faye Holton, Jacksonville, FL (US)

(72) Inventors: Hilton Randy Long, Jacksonville, FL (US); Tammy Faye Holton, Jacksonville, FL (US)

(21) Appl. No.: 19/436,591

(22) Filed: Dec. 30, 2025

Related U.S. Application Data
(60) Provisional application No. 63/740,187, filed on Dec. 30, 2024.

(51) Int. Cl. E06B 9/00

(52) U.S. Cl. CPC E06B 9/00; E06B 2009/007

(57) ABSTRACT

An inflatable barrier for preventing floodwater intrusion into interior spaces is disclosed. The barrier includes a rigid or semi-rigid panel sized to fit within a doorway, window frame, or other entryway of a dwelling. Inflatable tubing is mounted around the perimeter of the panel and, when inflated, expands outward to form a compressive, watertight seal against the surrounding frame. The assembly is lightweight, removable, and reusable, allowing a homeowner to quickly install or remove the barrier as needed. The device may be constructed from materials such as plexiglass, plastic, glass, or wood, with the inflatable tubing formed from rubber or similar flexible materials. The invention provides an efficient and adaptable means of protecting interior entryways from floodwater damage.

The current application claims a priority to the U.S. Provisional Patent application Ser. No. 63/740,187 filed on Dec. 30, 2024.

### FIELD OF THE INVENTION

The present invention relates generally to water protection devices and, more particularly, to a panel with an inflatable edge configured to prevent floodwater from entering interior entryways such as doors and windows.

### BACKGROUND OF THE INVENTION

Flooding events cause substantial damage to residential and commercial structures each year. Even minimal water intrusion can destroy flooring, drywall, furniture, and personal belongings. Conventional flood-prevention methods—such as sandbags—are often cumbersome, heavy, slow to deploy, and ineffective at forming a watertight seal around interior entryways.

There is therefore a need for a lightweight, reusable, easily installed barrier capable of sealing doorways, windows, and similar openings to prevent floodwater from entering interior spaces. The present invention addresses this need by providing an inflatable, form-fitting barrier that can be quickly deployed by a homeowner or occupant.

### SUMMARY OF THE INVENTION

The present invention provides an inflatable barrier assembly designed to seal interior entryways against floodwater intrusion. The barrier includes a rigid or semi-rigid panel—such as plexiglass, plastic, glass, or wood—cut to fit the dimensions of a doorway or window. Inflatable tubing is mounted around the perimeter of the panel. When inflated, the tubing expands outward to press against the surrounding frame, creating a watertight seal that prevents water from entering the protected area.

The barrier is lightweight, removable, and reusable. It can be custom-manufactured to fit a variety of entryway sizes and shapes. The inflatable tubing may be formed from rubber, such as repurposed or modified bicycle tubing, and may be attached to the panel using flanges, adhesives, fasteners, or molded integration.

### BRIEF DESCRIPTION OF THE DRAWINGS

FIG. 1 is a front view of the panel of the present invention.

FIG. 2 is a side view of the present invention.

FIG. 3 is a side view of the present invention.

FIG. 4 is a rear view of the present invention.

FIG. 5 is a front perspective view of the present invention.

FIG. 6 is a rear perspective view of the present invention.

FIG. 7 shows the present invention in use blocking an exterior door.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a panel to prevent floodwater from entering through doors and windows, embodiments of the present disclosure are not limited to use only in this context.

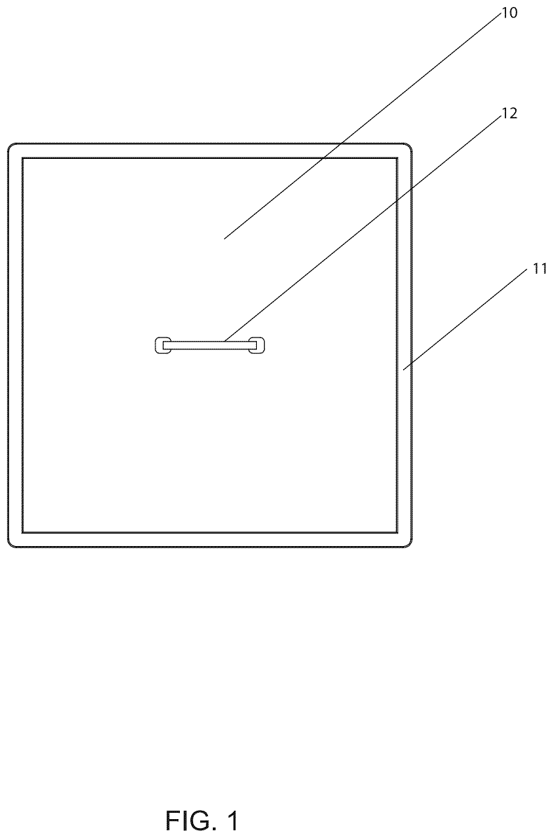

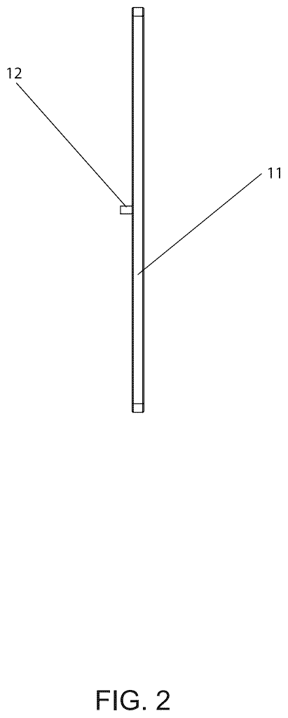

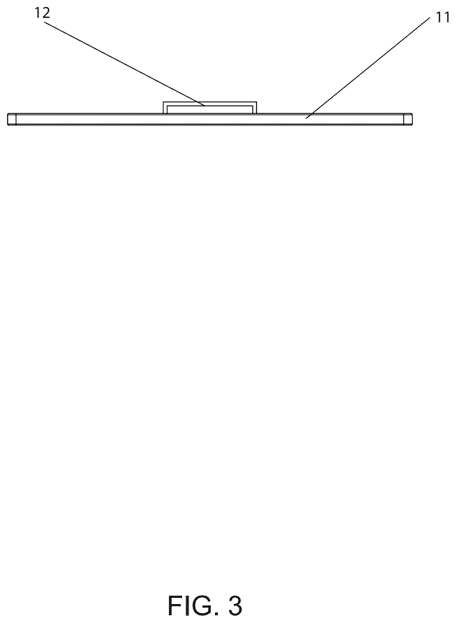

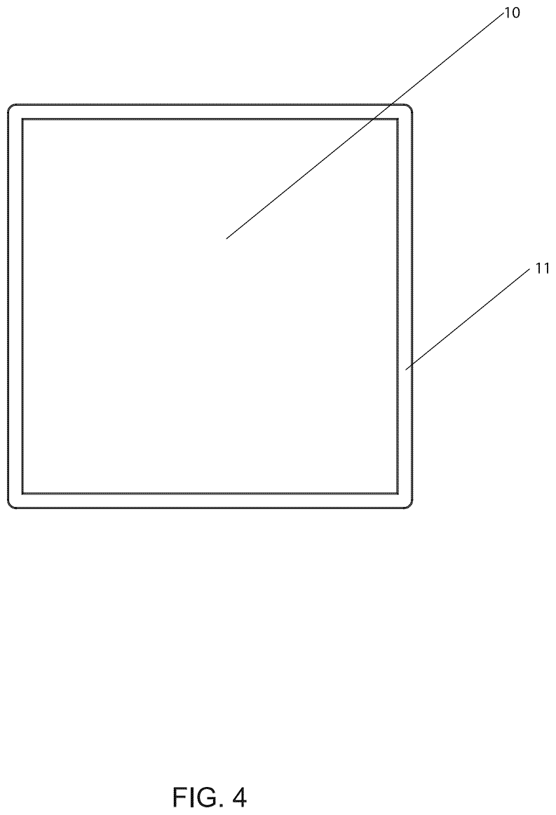

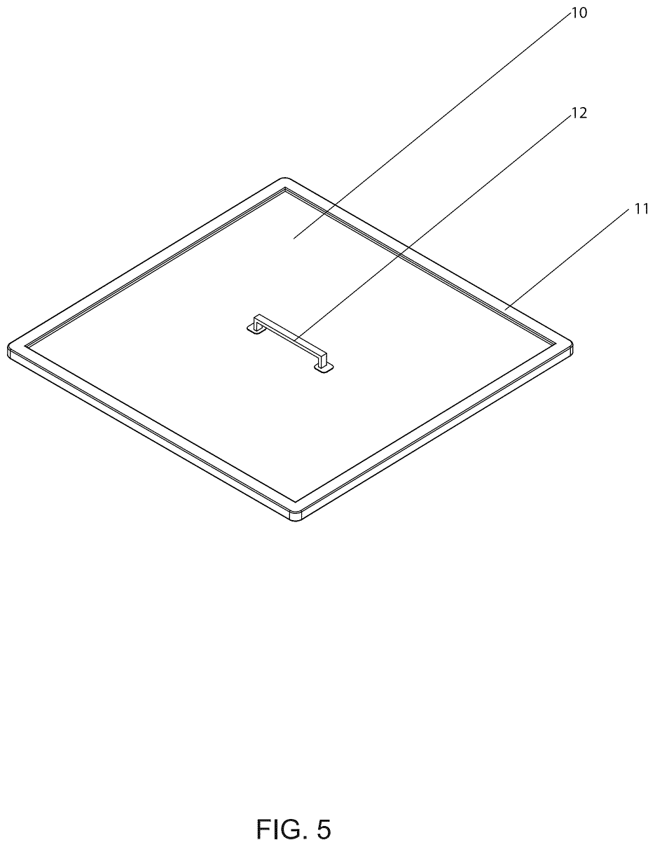

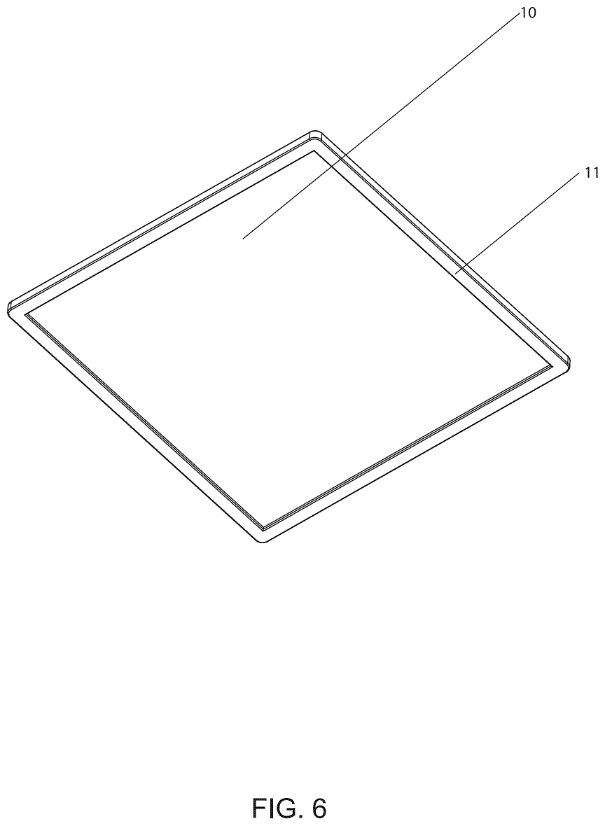

The present invention comprises an inflatable barrier assembly configured for installation within an interior doorway, window frame, or similar entryway. Referring now to FIGS. 1-6, the assembly includes a panel (10) formed from plexiglass, plastic, glass, wood, or other rigid or semi-rigid material. In a preferred embodiment, the panel (10) is formed from approximately ¾-inch plexiglass due to its strength, durability, and resistance to warping.

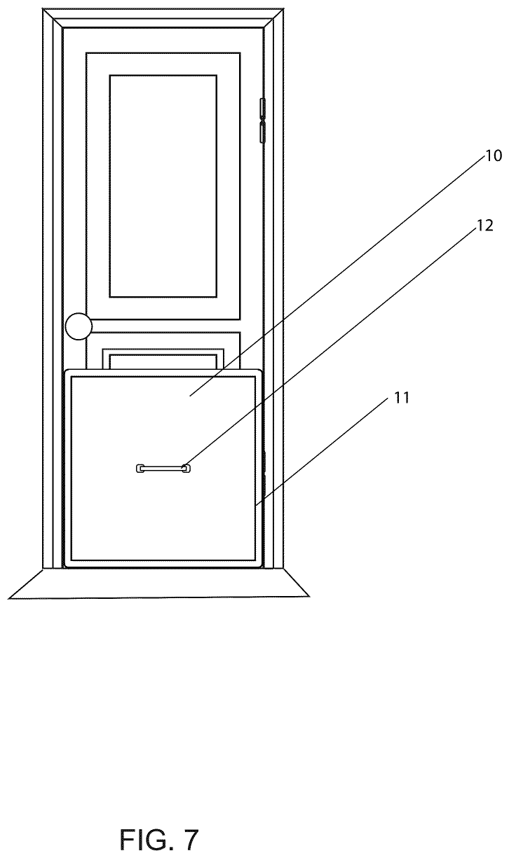

Inflatable rubber tubing (11) is mounted around the perimeter of the panel (10). The tubing (11) may be formed from bicycle-type rubber tubing or other flexible, air-tight materials. The tubing (11) may be secured to the panel (10) using flanges, brackets, adhesives, molded channels, or other attachment mechanisms. When deflated, the barrier can be easily positioned within the entryway. Once positioned, the tubing (11) is inflated manually, electrically, or via an external pump causing the tubing (11) to expand outward and press firmly against the surrounding frame, securing it within the doorway or window. FIG. 7 shows the present invention in use, secured within a doorway.

The expansion of the tubing (11) creates a compressive, watertight seal between the panel (10) and the entryway frame, thereby preventing floodwater from entering the interior space. The barrier may be installed or removed by a homeowner without specialized tools. The assembly may be manufactured in various shapes and sizes to accommodate different door and window sizes and configurations.

The panel (10) may further comprise a handle (12), preferably placed in the middle of the panel (10), allowing the user to easily carry, remove, and transport the panel (10).

Although the invention has been explained in relation to its preferred embodiment, it is to be understood that many other possible modifications and variations can be made without departing from the spirit and scope of the invention.

What is claimed is:

1. An inflatable barrier comprising,
a panel sized to fit within an entryway; and
inflatable tubing mounted around the perimeter of the panel, wherein inflation of the tubing causes the tubing to expand outward and form a seal between the panel and the entryway.

2. The inflatable barrier of claim 1, wherein the panel comprises plexiglass, plastic, glass, wood, or a combination thereof.

3. The inflatable barrier of claim 1, wherein the inflatable tubing comprises rubber tubing.

4. The inflatable barrier of claim 1, wherein the inflatable tubing is attached to the panel using flanges, brackets, adhesives, molded channels, or combinations thereof.

5. The inflatable barrier of claim 1, wherein the barrier is configured for installation in a doorway or window of a dwelling.

6. The inflatable barrier of claim 1, wherein the tubing is inflatable using a manual pump, electric pump, or integrated inflation mechanism.

7. The inflatable barrier of claim 1, wherein the panel further comprises a handle, allowing the user to remove, carry, and store the panel.

8. The inflatable barrier of claim 1, wherein the tubing forms a watertight seal when inflated.
